(19) United States
(12) Patent Application Publication
(10) Pub. No.: US 2006/0000376 A1
(43) Pub. Date: Jan. 5, 2006

(54) Stamp plate unit and self-inking stamp

(76) Inventor: Ernst Faber, Wels (AT)

Correspondence Address: WILLIAM COLLARD;COLLARD & ROE, P.C., 1077 NORTHERN BOULEVARD, ROSLYN, NY, 11576, US

(21) Appl. No.: 10/535,773

(22) PCT Filed: Nov. 6, 2003
(86) PCT No.: PCT/AT03/00333

§ 371 Date: May 20, 2005

(30) Foreign Application Priority Data
Nov. 21, 2002 (AT) GM 788/2002

(51) Int. Cl. B41F 27/00

(52) U.S. Cl. 101/382.1

(57) ABSTRACT

A stamp plate unit (4) comprising a stamp plate carrier (2) made of a first plastic material, and a stamp plate (1) which is applied to the stamp plate carrier (2) and provided for inking and made of at least one second plastic material that is soft compared to the first plastic material, wherein the stamp plate carrier (2) and the stamp plate (1) are made in one piece by means of a multicomponent injection molding process, as well as a self-inking stamp (5) provided with a turning mechanism and an inventive stamp plate unit (4).

The invention relates to a stamp plate unit comprising a stamp plate carrier made of a first plastic material and a stamp plate which is applied to the stamp plate carrier and provided for inking and made of at least one second plastic material that is soft compared to the first plastic material, as well as to a self-inking stamp comprising a turning mechanism.

From U.S. Pat. No. 5,809,886 A a self-inking stamp with a turning mechanism is known in which various stamp plates can be inserted in the stamp plate carrier like modules via a pin/hole plug-in connection. However, making such a plug-in connection is relatively time-consuming.

From WO 02/058937 A1, moreover, a self-inking stamp comprising a turning mechanism is known in which stamp characters can be fastened to a character unit by means of a plug-in connection. For this purpose, the character unit has recesses in which the insertion projections of the stamp characters can be inserted.

To fix a stamp plate on a stamp plate carrier, it is generally customary to use a double-faced adhesive tape, by means of which the comparatively soft stamp plate made of rubber or of plastic can be adhered to the stamp plate carrier made of a comparatively hard plastic material. What is disadvantageous in this case is that the adhesion is extremely time-consuming and costly.

Accordingly, it is an object of the present invention to provide a stamp plate unit as well as a self-inking stamp of the initially defined type, wherein the stamp plate unit can be produced at low costs as compared to known stamp plate units and, moreover, in a rapid and simple manner.

In the stamp plate unit according to the invention and of the initially defined type, this is achieved in that the stamp plate carrier and the stamp plate are made in one piece by means of a multicomponent injection molding process.

The material properties required for the stamp plate carrier in terms of strength, material durability and so on are particularly met if as the first plastic material, polyoxymethylene (POM) or the like is provided, wherein POM moreover also is suitable to be processed by means of a multicomponent injection molding process. Naturally, also other materials suitable for a multicomponent injection molding process, such as, e.g., acrylonitrile butadiene styrene copolymers (ABS), polypropylene (PP), polyamide (PA), polycarbonate (PC) or PC/ABS may be used.

When choosing the soft plastic material for the stamp plate, besides the requirement that the former is suitable for a multicomponent injection molding process, particularly the wettability as well as the quality of the imprint must be considered, wherein in this connection it has proven particularly advantageous if the second plastic material of the stamp plate has a Shore hardness A of substantially 50 to 60. Tests have shown that the aforementioned criteria in terms of wettability, quality of imprint and also the simple manufacture by a multicomponent injection molding process are met in particular if a thermoplastic elastomer (TPE) or the like is provided as the second plastic material.

In order to design the stamp image of the stamp plate variable at least in parts thereof by allowing individual stamp symbols to be detachably inserted in the stamp plate, it is advantageous if the stamp plate comprises at least in parts thereof a groove or web structure for the insertion of stamp symbols. By this design, a secure hold of inserted stamp symbols in the stamp plate is ensured. Moreover, insertion and/or removal of the stamp symbols can be effected in a simple manner.

Regarding a simple, cost-effective manufacture and an attachment of the stamp symbols on the stamp plate without any problems, it is advantageous if the groove or web structure comprises at least one groove or web having a rectangular, in particular a square, cross-section. As an alternative thereto, it is also possible that the groove or web structure comprises at least one groove or web having a trapezoidal, rhomboidal or comparable cross-section, the assembled webs and grooves thereby having cross-sections engaging one behind the other, which will reliably result in a tight connection between the stamp symbols and the stamp plate.

The self-inking stamp according to the invention and of the initially defined type is characterized in that a stamp plate unit according to any one of claims 1 to 8 is provided. By providing a stamp plate unit according to any one of claims 1 to 8, the advantages already previously mentioned with regard to the stamp plate unit will result in connection with the self-inking stamp, and reference is made to what has been said before so as to avoid repetitions.

In the following, the invention will be explained in more detail by way of preferred exemplary embodiments illustrated in the drawings to which, however, it shall not be restricted. In detail, in the drawings,

FIG. 1a shows an exploded, perspective view of a stamp plate unit comprising a round stamping face according to the prior art;

FIG. 1b shows a perspective view of a stamp plate unit according to the invention having a round stamping plate and produced in a multicomponent injection molding process;

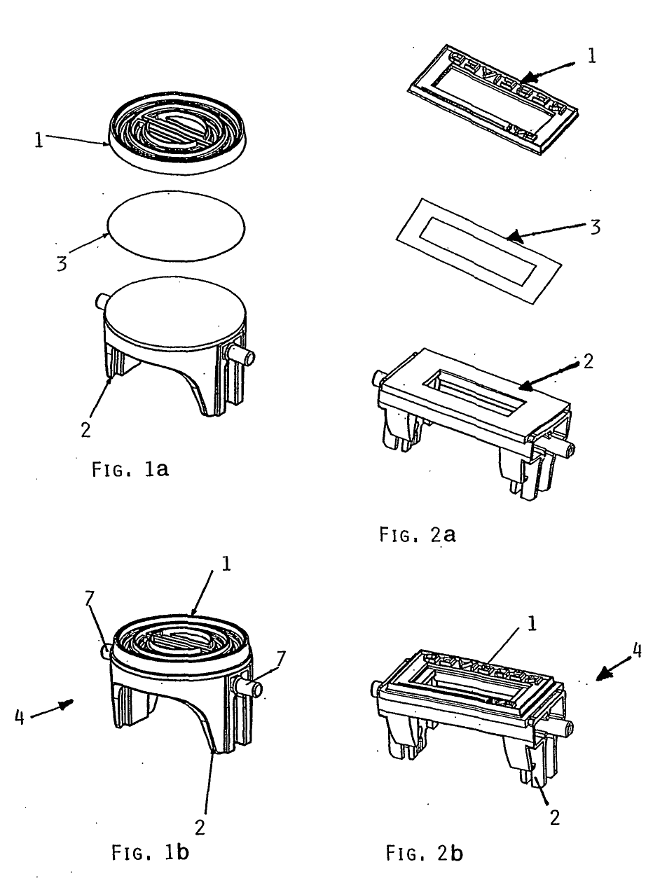

FIG. 2a shows an exploded, perspective view of a stamp plate unit according to the prior art comprising a rectangular stamp plate with a central recess;

FIG. 2b shows a perspective view of a stamp plate unit according to the invention comprising a rectangular stamp plate with a central recess, provided by means of a multicomponent injection molding process;

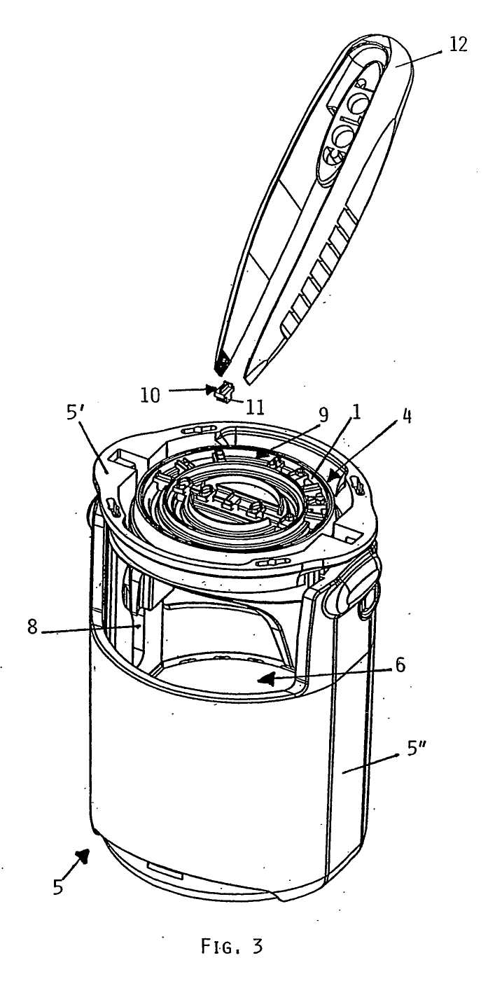

FIG. 3 shows a perspective view of the self-inking stamp comprising a turning mechanism and a stamp plate unit produced by means of a multicomponent injection molding process.

In FIGS. 1a and 2a, the individual components of stamp plate units according to the prior art are shown, each in an exploded illustration, comprising a stamp plate 1 made of rubber or caoutchouc, a stamp plate carrier 2 as well as a double-faced adhesive film 3 by means of which the rubber or caoutchouc stamp plate 1 is bonded to the stamp carrier 2.

On the other hand, in FIGS. 1b and 2b stamp plate units 4 are shown, consisting of one single piece and produced in a two-component injection molding process. In this case, the stamp plate carrier 2 consists of a relatively hard thermoplastic plastic material, e.g. POM, which is suitable for a production in one piece by means of a two-component injection molding process with a softer, elastomer plastic material of the stamp plate 1. By the production in one single piece, thus, bonding of the stamp plate 1 by means of an adhesive film 3 is omitted, so that with the production in a two-component injection molding process, a cost-efficient arrangement which, at the same time, fulfills all the requirements made on the stamp plate unit 4 with regard to strength of the stamp plate carrier 2 and wettability and quality of imprint of the stamp plate 1 is achieved.

In FIG. 3, a perspective view of a self-inking stamp 5 comprising a housing 5′ and a bracket 5″ arranged so as to be displaceable relative to the housing 5′ against the force of a spring (not shown), in which bracket the stamp plate unit 4 shown in FIG. 1b is pivotably mounted. In the housing 5′, furthermore, an ink pad 6 impregnated with ink for inking the stamp plate 1 is received. For realizing an automatic turning mechanism, guiding pins 7 of the stamp plate unit 4 (cf. FIG. 1b) are received in a groove guide 8 of the housing 5′ so that the stamp plate unit 4 carries out a turning movement when the bracket 5″ is shifted towards the housing 5′.

Moreover, it can be seen in FIG. 3 that the stamp plate 1 has grooves 9 in which stamp symbols 10 can be inserted with webs 11 corresponding to the grooves 9, resulting in a variable stamp image. By means of tweezers 12, the stamp symbols 10 can be inserted in the, in cross-section substantially dove-tail-shaped grooves 9 of the stamp plate 1 and also removed therefrom in a simple manner.

This results in a stamp plate unit 4 produced in a two-component injection molding process, which unit can be manufactured at low costs in a single process step and thus is particularly well suited for a production in large numbers. Yet, due to the grooves 9 provided for receiving stamp symbols 10, it is at the same time possible to obtain an individual, variable stamp image.

Apart from the rectangular and/or round shape illustrated, the stamp plate may, of course, have any other shape desired, e.g. oval or square, and it may also contain any recesses desired.

1-8. (canceled)

9. A stamp plate unit (4) comprising a stamp plate carrier (2) made of a first plastic material, and a stamp plate (1) which is applied to the stamp plate carrier (2) and provided for inking and made of at least one second plastic material that is soft compared to the first plastic material, wherein the stamp plate carrier (2) and the stamp plate (1) are made in one piece as a multicomponent injection molded part.

10. A stamp plate unit according to claim 9, wherein polyoxymethylene (POM), acrylonitrile-butadiene-styrene copolymers (ABS), polypropylene (PP), polyamide (PA), polycarbonate (PC) or PC/ABS is provided as the first plastic material.

11. A stamp plate unit according to claim 9, wherein the second plastic material of the stamp plate (1) has a Shore A hardness of substantially 50 to 60.

12. A stamp plate unit according to claim 9, wherein a thermoplastic elastomer (TPE) or the like is provided as the second plastic material.

13. A stamp plate unit according to claim 9, wherein the stamp plate (1) at least in parts thereof has a groove or web structure for insertion of stamp symbols (10).

14. A stamp plate unit according to claim 13, wherein the groove or web structure comprises at least one groove (9) or web having a rectangular, in particular a square, cross-section.

15. A stamp plate unit according to claim 13, wherein the groove or web structure comprises at least one groove (9) or web having a trapezoidal, rhomboidal or comparable cross-section.

16. A self-inking stamp (5) with a turning mechanism, wherein a stamp plate unit (4) according to claim 9 is provided.
